(19) United States
(12) Patent Application Publication
(10) Pub. No.: US 2026/0042678 A1
(43) Pub. Date: Feb. 12, 2026

(54) RECYCLE STREAM FOR LITHIUM EXTRACTION FROM BRINE

(71) Applicant: ExxonMobil Technology and Engineering Company, Spring, TX (US)

(72) Inventors: Lucas M. SANDER, Stirling, NJ (US); Sean A. MASON, Houston, TX (US); Keith H. KUECHLER, Friendswood, TX (US)

(21) Appl. No.: 19/292,561

(22) Filed: Aug. 6, 2025

Related U.S. Application Data
(60) Provisional application No. 63/680,893, filed on Aug. 8, 2024.

(51) Int. Cl. C01D 15/08; B01D 15/36; B01D 61/02

(52) U.S. Cl. CPC C01D 15/08; B01D 15/361; B01D 61/025; B01D 61/027

(57) ABSTRACT

A composition, apparatus, and method for enabling improved direct lithium extraction. An exemplary embodiment provides a method of producing a recycle stream. The method includes receiving a nanofiltration waste stream, a product wash waste stream, and a lithium carbonate reaction waste stream, or any combination thereof. The method includes blending at least a fraction of each of at least two of: the nanofiltration waste stream, the product wash waste stream, and the lithium carbonate reaction waste stream to generate the recycle stream.

### CROSS-REFERENCE TO RELATED APPLICATION

This application claims priority to and the benefit of U.S. Provisional Application No. 63/680,893, entitled “RECYCLE STREAM FOR LITHIUM EXTRACTION FROM BRINE,” having a filing date of Aug. 8, 2024, the disclosure of which is incorporated herein by reference in its entirety.

### FIELD

The present techniques generally relate to extraction of metals from brines. More specifically, the present techniques are directed towards methods and apparatuses for extraction of lithium from brines.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Metals such as lithium are extracted from different sources for use in various products, including batteries. For example, lithium may take the form of lithium compounds, such as lithium carbonate or lithium hydroxide. Technical grade lithium carbonate is approximately 99% lithium carbonate by weight. The purity standard for battery-grade lithium carbonate may exceed 99.5%.

One available source of lithium is from brines containing lithium among other metals. Such brines may be obtained from various sources. A number of brine sources exist naturally. For example, brine sources include brine deposits like the Salar de Atacama in Chile, Silver Peak Nevada, Salar de Uyuni in Bolivia, the Salar de Hombre Muerte in Argentina, or the Smackover Formation in Arkansas, among other natural deposits.

One currently used method of obtaining metals such as lithium from brines involves the use of solar evaporation ponds. In solar evaporation ponds, evaporation is used to enrich the brine and thus increase the concentration of metals in the brine. Chemical treatments may then be used to purify the brine and reduce impurities. The purified brine may then be converted into a lithium compound via a conversion process. For example, the conversion process may involve the use of a crystallization process to produce the lithium compound. The crystallizers may require a feed brine input with lithium concentrations in excess of about 60,000 parts per million (ppm) and impurity concentration of less than 500 ppm. By contrast, the water chemistry from commercial brine sources may tend to have lithium concentrations on the order of 100-1,000 ppm and a total dissolved solid concentration exceeding 350,000 ppm. Solar evaporation may thus be used to increase lithium concentrations, with chemical treatments to reduce impurities.

However, the usage of solar evaporation ponds may be restricted to use in arid environments that tend to be at high altitudes and remote. Moreover, production time using solar evaporation ponds is long, potentially taking up to 18 months to reach adequate concentrations of lithium or other metals. In addition, solar evaporation has a low selectivity to lithium that requires higher quality brines while recovering less than 50% of lithium. Finally, solar evaporation methods have large land requirements as well as a need for fresh water in arid environments. An improved process of lithium production is desirable.

### SUMMARY

An exemplary embodiment provides an apparatus for brine filtration. The apparatus includes a recycling unit to receive a nanofiltration waste stream, a product wash waste stream, a lithium carbonate reaction waste stream, or any combination thereof. The recycling unit is also to blend at least a fraction of each of at least two of: the nanofiltration waste stream, the product wash waste stream, and the lithium carbonate reaction waste stream to generate a recycle stream.

Another exemplary embodiment provides a method of producing a recycle stream. The method includes receiving a nanofiltration waste stream, a product wash waste stream, a lithium carbonate reaction waste stream, or any combination thereof. The method also includes blending at least a fraction of each of at least two of: the nanofiltration waste stream, the product wash waste stream, and the lithium carbonate reaction waste stream to generate the recycle stream.

These and other features and attributes of the disclosed embodiments of the present disclosure and their advantageous applications and/or uses will be apparent from the detailed description that follows.

### BRIEF DESCRIPTION OF THE DRAWINGS

The advantages of the present techniques are better understood by referring to the following detailed description and the attached drawings, in which:

FIG. 1 is a block diagram of an apparatus for the extraction of lithium from a lithium-containing brine using a recycle stream, according to embodiments herein;

FIG. 2 is a block diagram of another apparatus for the removal of ions from a brine stream using a recycle stream and secondary lithium extraction, according to an embodiment;

FIG. 3A is a process flow diagram of a method for recycling waste streams, according to an embodiment;

FIG. 3B is a process flow diagram of a method for recycling waste streams using a secondary lithium extraction unit, according to another embodiment; and

FIG. 4 is a chart depicting components of various example streams.

It should be noted that the figures are merely examples of the present disclosure and are not intended to impose limitations on the scope of the present disclosure. Further, the figures are generally not drawn to scale, but are drafted for purposes of convenience and clarity in illustrating various aspects of the present disclosure.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to. ” The term “coupled” means directly or indirectly connected. The word “exemplary” is used herein to mean “serving as an example, instance, or illustration. ” Any aspect described herein as “exemplary” is not necessarily to be construed as preferred or advantageous over other aspects. The term “uniform”means substantially equal for each sub-element, within about ±10% variation.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or”clause, whether related or unrelated to those entities specifically identified.

Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on. ” As used herein, “brine” or “brine solution” refers to any aqueous solution that contains a substantial amount of dissolved metals, such as alkali and/or alkaline earth metal salt(s) in water, wherein the concentration of salts can vary from trace amounts up to the point of saturation. Generally, brines suitable for the methods described herein are aqueous solutions that may include alkali or alkaline earth metal chlorides, bromides, sulfates, hydroxides, nitrates, and the like, as well as natural brines. In certain brines, other metals like lead, manganese, and zinc may be present. Exemplary elements present in the brines can include sodium, potassium, calcium, magnesium, lithium, strontium, barium, iron, boron, silica, manganese, chlorine, zinc, aluminum, antimony, chromium, cobalt, copper, lead, arsenic, mercury, molybdenum, nickel, silver, thallium, vanadium, and fluorine, although it is understood that other elements and compounds may also be present. Brines can be obtained from natural sources, such as Chilean brines or Salton Sea brines, geothermal brines, Smackover brines, sea water, mineral brines (e.g., lithium chloride or potassium chloride brines), alkali metal salt brines, and industrial brines, for example, industrial brines recovered from ore leaching, mineral dressing, and the like. Brines include continental brine deposits, geothermal brines, and waste or byproduct streams from industrial processes, synthetic brines, and other brines resulting from oil and gas production. In some embodiments, the brines are brines from which energy has already been extracted. For instance, brines used herein include brines from which a power plant has already extracted energy through methods such as flashing.

The term “concentrated” in reference to a brine (e.g., “concentrated brine” or “concentrated deep subsurface brine”) refers to brines that have reduced water content compared to the original brine. The reduced water content brine may be subsequently diluted post-concentration to prevent salt precipitation. In some embodiments, concentrated brines can result from various stages used during a direct lithium extraction (DLE) process or concentration, refinement, and conversion (CRC) process.

The term “deep subsurface brine” refers to a saline solution that has circulated through rocks deep in reservoirs such as those found in East Texas, North Dakota, and Arkansas in the United States, and in Alberta, Canada.

The term “divalent” refers to an element having two valence electrons. Example divalents discussed herein include calcium and magnesium.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

The term “filter train” refers to a series or sequence of multiple filtration stages or units arranged in a specific order to remove particulate matter, impurities, or other undesirable substances from a fluid stream. The filter train involves using a step-by-step approach to filtration, with each stage designed to target specific particle sizes or types of contaminants. The goal may be to achieve a high level of filtration efficiency and ensure that a final product meets required quality standards.

The term “geothermal brine” refers to a saline solution that has circulated through the crustal rocks in areas of high heat flow and has become enriched in substances leached from those rocks. Geothermal brines, such as those found in the Salton Sea geothermal fields, can include many dissolved metal salts, including alkali, alkaline earth, and transition metal salts.

The term “lithium salts” can include lithium nitrates, lithium sulfates, lithium bicarbonate, lithium halides (particularly chlorides and bromides), and acid salts. For example, the Salton Sea brines have lithium chlorides.

As used herein, “lithium selectivity” refers to the ability of a sorbent to preferentially extract lithium while rejecting impurities.

As used herein, “loading capacity”refers to the extracted lithium per unit of sorbent.

As used herein, the term “monovalent” refers to an element having one valence electron. Example monovalents discussed herein include sodium, potassium, and lithium.

The term “Smackover brine” refers to a type of mineral-rich water that is found in the Smackover Formation, a geological layer that formed during the Jurassic period and spans across several states in the southern United States. Smackover brines are considered a resource for lithium and bromine in particular. Smackover brines may be extracted from the Smackover Formation by pumping them from wells that reach the limestone aquifer. The brines are then processed to separate the lithium and bromine from the water and other minerals.

The term “treated” in reference to a brine (e.g., “treated brine”) refers to brines that have been processed such that the concentration of at least one metal or elemental component has been reduced in the brine. For instance, a brine in which the concentration of silica and iron has been reduced is a treated brine, also referred to as reduced silica and iron brine.

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments.

Accordingly, the techniques are not limited to the specific embodiments described below, but rather, include all alternatives, modifications, and equivalents falling within the true spirit and scope of the appended claims.

Direct lithium extraction (DLE) is a selective lithium extraction process that enables selective recovery of lithium from a complex mineral mix of brine. DLE has lower recovery times in the order of hours or days rather than months. Moreover, DLE enables from 50% to greater than 90% recovery of lithium from brines. In addition, DLE utilizes less land area and can be conveniently deployed anywhere. The present techniques relate to preparing brine so that it is suitable for efficient processing via DLE. The present techniques also generally relate to compositions of treated brine having reduced concentrations of hydrogen sulfide (H2S). The present technological innovation generally relates to compositions for preventing sorbent poisoning and pipe corrosion. These techniques generally relate to treated brine compositions with reduced concentrations of H2S that can also be used for recovery of metals, including lithium, manganese, rubidium, cesium, and potassium.

DLE can be integrated with other technologies for production of lithium product. For example, such technologies may include a precipitator, reverse osmosis, filtration, multi-effect evaporator, and crystallizer, or any combination thereof. Sorption-based techniques are also used for recovery of lithium. For example, a lithium-aluminum-layered double hydroxide chloride sorbent (LAH or AlOH) is sometimes used. DLE today is typically used on salt lake assets. DLE salt lake brine producers make use of evaporation ponds to assist with the pre-treatment, impurity removal, and dewatering, and do not re-inject the water back into the reservoir. However, the water chemistries may have much less impurities than deep subsurface brines because such DLE producers either produce the lithium from the tailings of other brine operations or they target resources for their low impurity concentrations. For example, some producers process their lithium from the brine tailings of their potash operations, which significantly cleans up the water. Some other DLE operations have specifically targeted salt lakes with water chemistries that are more suitable for DLE.

Thus, a different DLE flow may be used on deep subsurface brines as compared to DLE operations with ponds. In particular, the need for impurity removal and dewatering steps may be greater and thus addressed solely with industrial facilities. The key cost drivers may thus be determined by the cost associated with each processing step (i.e. pre-treatment, the DLE step, impurities removal, and dewatering to enhance lithium concentration), and can be categorized as robustness to water chemistry, lithium selectivity, and loading capacity. The three of these processing steps—pre-treatment, impurity removal, and dewatering—are all tied directly to the DLE process, and therefore, the costs are not necessarily independent of one another, as described in greater detail below. Generally, with respect to robustness to water chemistry, the pre-treatment steps prior to DLE must process the largest volume up front, such as chemical treatment or filtration, to remove impurities that cause unsafe operations, scaling issues, or deteriorate sorbent performance.

DLE technology robustness against a wide range of water chemistries can minimize the need for pre-treatment and its cost. With respect to lithium selectivity and loading capacity, the lithium concentrated stream after DLE may still require further refinement to produce a battery grade product, thus necessitating additional post-treatment. The amount of impurities remaining after DLE is determined by the lithium selectivity, while the lithium concentration post DLE is determined by the loading capacity of the sorbent. Post DLE processes are designed to remove residual impurities, boost lithium concentration, and convert to high purity lithium carbonate or lithium hydroxide, and therefore, post-treatment processes will endure more cost for larger quantities of impurities and lower lithium concentrations post-DLE. For example, post DLE processes may include chemical treatments, filtration, dewatering, and crystallization.

While these cost drivers are described independently, they can be highly correlated. For example, lithium selectivity, loading capacity, and robustness may all be tied to the same or correlated physical mechanisms. Another additional complexity is that the mechanisms that enable the use of a particular material in the DLE step to selectively extract lithium rely on thermodynamically favored conditions, and different source brines will be unique in their make-up, and even small differences in water chemistry may alter the thermodynamics in a manner that also influences lithium selectivity and loading capacity. Therefore, these key cost drivers cannot be considered independent of one another or in the absence of the water chemistry under consideration. Therefore, DLE may work best if engineered for a specific lithium deposit. Unlike pond-assisted DLE, the spent brine may also need to be re-injected or cleaned prior to surface discharge.

In various examples, the output of a DLE unit may be input into various other units for conversion of the stream into lithium. However, the various components of the conversion process may produce byproduct streams that may include amounts of lithium. Thus, the conversion process may not be completely efficient in converting a lithium brine into a refined lithium product.

Accordingly, embodiments described herein enable improved recovery of lithium and other metals from deep subsurface brines, among other sources of brine. In one embodiment, a conversion process is described with a recycled brine stream that increases the percentage of lithium recovered from the brine. An associated recycled brine composition for improved lithium recovery is also described. The use of such a recycled brine composition may enable increased lithium recovery by reducing the amount of lithium wasted in waste streams, including nanofiltration waste, product wash waste, and lithium carbonate reaction waste streams. In one embodiment, a method for efficient preparation of a recycled brine feed is described. The blended mixture may be input directly into the DLE unit for recycling. The techniques described herein thus enable a recycle stream to be fed back into the DLE unit and thus additionally processed without special adaptation for each waste stream. In this manner, the techniques enable the waste streams to be further processed using existing systems to extract additional lithium. In particular, using techniques described herein, a simulation resulted in an increase of lithium extraction efficiency from 70% to an efficiency of 90%. Thus, the techniques may increase lithium extraction efficiency without significantly increasing overall costs. Furthermore, the techniques may enable less nanofiltration modules to be used to achieve the same lithium extraction levels. For example, a smaller amount of filtration material that allows more lithium to pass through at a higher flux rate may be used and may still result in the same overall amount of lithium to be extracted using the techniques herein. For example, a higher flow rate and thus flux rate may be used to remove more divalent ions, but this may capture lithium less efficiently in a single pass. A system may thus pass more lithium to reject for improved divalent removal, with the knowledge that the increased lithium pass through would have a second pass through the recycling system. In addition, the techniques may also enable wash waste system to operate sub-optimally, removing further amounts of sodium and lithium with the knowledge that the increased lithium would have a second pass through the recycling system. Thus, a strategy of allowing more lithium loss to remove more impurities overall is enabled using the present techniques.

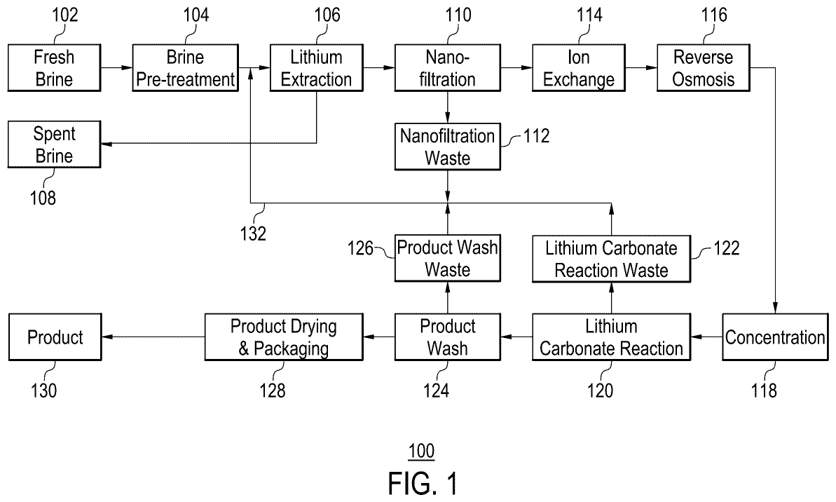

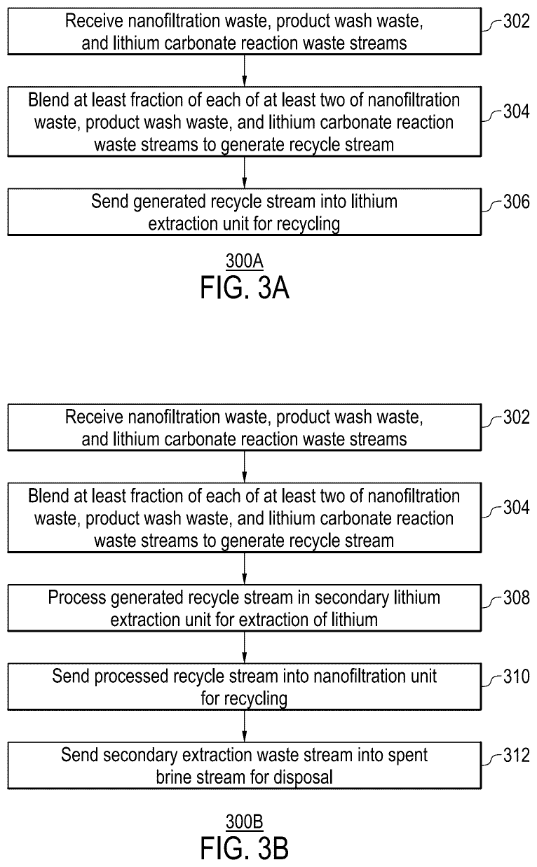

Referring now to FIG. 1, an apparatus 100 for the removal of lithium from a lithium containing brine is provided. In various embodiments, the apparatus 100 is used to implement the method 300A of FIG. 3A.

In various embodiments, a fresh brine 102 containing lithium and other metals is provided via a well or other source. For example, the fresh brine 102 received from well may be a deep subsurface brine. A brine pre-treatment unit 104 may then generally pretreat the brine to produce a pretreated brine. As one example, the brine pre-treatment unit 104 pretreats the brine to remove hydrogen sulfide and hydrocarbons. In various embodiments, the brine pre-treatment unit 104 may include the use of various technologies. For example, in some embodiments, the brine pre-treatment unit 104 pretreats the fresh brine 102 to remove vapor, solids, and organics from the output stream. For example, the vapor can include water vapor as well as other gases, such as methane, ethane, propane, carbon dioxide, and nitrogen, among other gases. In various examples, solids can include larger particles, such as solidified sulfates, phosphate, carbonates, silicas, sands, bits of rock, dirt, etc. In various examples, the organics can include methane, ethane, propane, butanes, pentanes, hextanes, heplanes-plus, carbon dioxide, hydrogen sulfide, pentanes-plus, etc. In some embodiments, the brine pre-treatment unit 104 includes a sparging tank. For example, a sparging tank may be used by controlling the amount of air injected into the sparging tank to vary the composition of the fresh brine 102. In particular, the air is used to knockout iron, silica, and entrained gas in the fresh brine 102 via chemical reactions. In some examples, the exact rate of air injection and vessel size of the of the sparging tank can be optimized based on the target composition of the fresh brine 102. In some embodiments, the brine pre-treatment unit 104 includes a three-phase separator. For example, the three-phase separator can remove gases and solids from the fresh brine 102. In some embodiments, the brine pre-treatment unit 104 includes a desander. For example, a desander uses a cyclone and centrifugal force to separate larger solids from brine droplets. Such larger solids may include various larger particles, such as sand or bits of rock on the scale of micrometers in size. In some embodiments, the brine pre-treatment unit 104 includes a de-oiling cyclone. For example, the de-oiling cyclone can perform an additional cyclone removal for more trace oil from the fresh brine 102. In various embodiments, such removed trace oils include acetate, propionate, glycolate, and/or formate, among other potential trace oils.

In various embodiments, the pretreated brine is sent to a lithium extraction unit 106, which filters the pretreated brine into a lithium-rich brine. In various embodiments, the lithium extraction unit 106 is a direct lithium extraction (DLE) unit that is fluidically coupled to the brine pre-treatment unit 104. The lithium extraction unit 106 processes the pretreated brine to increase both the ratio of lithium to impurities and the lithium concentration. In various embodiments, regardless of the technique and materials used, the lithium extraction is accomplished by swapping lithium out of the source brine into a fresh water stream (not shown). In various examples, depending on the techniques applied, additional reagents may also be added to the fresh water stream. For example, such reagents may include sodium sulfate (Na₂SO₄), sodium hydroxide (NaOH), sodium carbonate (Na₂CO₃), hydrochloric acid (HCl), or sulfuric acid (H₂SO₄), among other reagents. Each of the steps before and after lithium extraction unit 106 are thus tied to the lithium extraction process and the materials used to promote this swap. In some embodiments, if impurities in the water would harm the lithium extraction unit 106, then these impurities are first removed, and this is done in the brine pre-treatment unit 104 as described above.

The results of the lithium extraction process at the lithium extraction unit 106 is a spent brine 108 that and a lithium rich water stream that is sent to a nanofiltration unit 110. In various embodiments, the spent brine 108 is collected from lithium extraction unit 106 and disposed either onto the surface or re-injected into a subsurface reservoir. In some embodiments, the spent brine 108 is deposited back into a well. In some embodiments, the spent brine 108 may be additionally treated before being injected into the well. For surface disposal, regulatory approval may be required, and depending on location, large quantities of impurities may first be removed. For reinjection into a reservoir, retention of impurities are required to ensure compatibility with the original subsurface brine. In some embodiments, if too many components are depleted from or added to the spent brine relating to the pre-treatment and lithium extraction processes, then the spent brine 108 is rebalanced before reinjection in order to be compatible with the subsurface brine. Otherwise, an incompatible brine may present a risk of excessive scaling and improper pressure maintenance of the reservoir or well.

In various examples, there may be some amount of impurities that remain in the lithium rich water stream after the lithium extraction process at lithium extraction unit 106. For example, no material and technique that can perfectly select for lithium may exist. In various examples, such remaining impurities may include calcium (Ca), boron (B), magnesium (Mg), sodium (Na), strontium (Sr), silicon (Si), zinc (Zn), iron (Fe), potassium (K), argon (Ar), lead (Pb), nickel (Ni), or copper (Cu), among other remaining impurities. Therefore, in various embodiments, the apparatus 100 includes a nanofiltration unit 110 to remove some remaining impurities into a nanofiltration waste stream 112. In various embodiments, the lithium rich water stream from the lithium extraction process may be processed through any number of nanofilters to remove any variety of ions. On the permeate side of the nanofiltration unit 110 that is sent to the ion exchange unit 114, monovalents such as sodium, lithium and potassium are allowed to go through, such that the nanofiltration waste stream 112 is very low in these monovalents and really high in divalents. In various embodiments, the nanofiltration unit 110 is configured to remove solids from nanometer sized ions dissolved in solution. For example, each of any number of nanofilters may include nano-sized holes through which the brine is passed at a certain flux rate and a certain pH, both of which may depend on the composition of the lithium rich water stream. For example, a stream having high amounts of boron may be processed with a different pH than a stream having low amounts of boron. Similarly, a stream with high amounts of impurities may be processed at a higher flux in order prevent scaling. In various examples, there may be a tradeoff between how much lithium is recovered by the apparatus 100 and how many ions are rejected by the nanofiltration unit 110.

Therefore, the flux rate may also be kept lower in order to enable more lithium to be efficiently extracted. However, the use of a higher flux rate may be enabled by the use of the recycling described herein, which allows additional lithium to be recovered that would have otherwise been wasted. The nanofiltration waste stream 112 may have high concentrations of divalents. For example, the output nanofiltration waste stream 112 may include some lithium, along with higher concentrations of divalents such as calcium and magnesium, that may otherwise have been returned to a well, but are instead recycled as described herein. For example, the nano-filtering of a lithium rich water stream with 600 PPM calcium may result in a nanofiltration waste stream 112 with a concentration of calcium in the range of 4,000 to 8,000 PPM. The nanofiltration unit 110 also generates a filtered stream that is sent to the ion exchange unit 114.

The filtered stream from the nanofiltration unit 110 is sent to an ion exchange unit 114 for further removal of impurities. In various embodiments, the ion exchange unit 114 is fluidically coupled to the nanofiltration unit 110. The ion exchange unit 114 can interchange of one species of ion present in an insoluble solid with another of like charge present in a solution surrounding the solid. In various embodiments, the insoluble solid is a resin containing a particular ion on its surface. In one embodiment, the resin has sodium (Na+) ions along its surface. In various embodiments, the ions on the resin have higher affinity for divalents, as well as trivalents such as iron ions (Fe+++). In some embodiments, the ion exchange unit 114 is used to remove divalents and replace them with sodium ions. In one embodiment, the brine flows over the resin and divalents are swapped for sodium ions in the output brine. In various embodiments, the resin-based bed hits saturation and taken offline to regenerate the resin. Thus, in various embodiments, multiple ion exchange beds are used to allow for continuous operations. In some embodiments, the ion exchange beds may include a resin specifically configured for boron and another resin specifically configured for divalents. The output of the ion exchange unit 114 is sent for further filtration at the reverse osmosis unit 116.

In various embodiments, the apparatus 100 thus also includes a reverse osmosis (RO) unit 116 is fluidically coupled to the ion exchange unit 114. The RO unit 116 includes a membrane used to filter solvents from various solutes. In various embodiments, RO retains the solute on the pressurized side of the membrane and the purified solvent passes to the other side. In some embodiments, the reverse osmosis permeate or purified solvent is purified water. For example, the RO unit 116 can filter lithium solutes as well as other solutes, such as sodium. These solutes are sent in a stream to the concentration unit 118. In some embodiments, the RO unit 116 is a medium pressure reverse osmosis unit. In various embodiments, a medium pressure reverse osmosis unit may operate within the range of 600 to 1,800 pounds per square inch (psi), or 4,137 to 12,410 kilopascals (kPa). In some embodiments, the RO unit 116 is a high pressure reverse osmosis unit. In various embodiments, a high pressure reverse osmosis unit operates at a pressure of greater than 1,800 psi or 12,410 kPa. In some embodiments, the RO unit 116 includes a mix of medium pressure reverse osmosis and high pressure reverse osmosis filters. In various embodiments, the RO unit 116 can filter out lithium and other elements from the stream and output reverse osmosis permeate containing water and less than 1% of the feed lithium and sodium, as well as boron. In various embodiments, the amount of lithium in the reverse osmosis permeate is less than 1000 ppm total. For example, the amount of lithium may be lower than 100 ppm. In some embodiments, the purified solvent is used as wash water or for lithium extraction in the lithium extraction unit 106.

The apparatus 100 includes a concentration unit 118 fluidically coupled to receive purified lithium solution from the reverse osmosis unit 116. In various embodiments, the concentration unit 118 executes a dewatering process to remove the water from the purified lithium solution. In some embodiments, the concentration unit 118 includes an evaporator unit. The evaporator unit is used to evaporate additional solvents such as water from the purified lithium solution. In some embodiments, the resulting vapor is released into the environment. In some embodiments, the vapor is cooled and condensed in the evaporator unit and reused as a source of water. In one embodiment, condensed vapor is used as wash water.

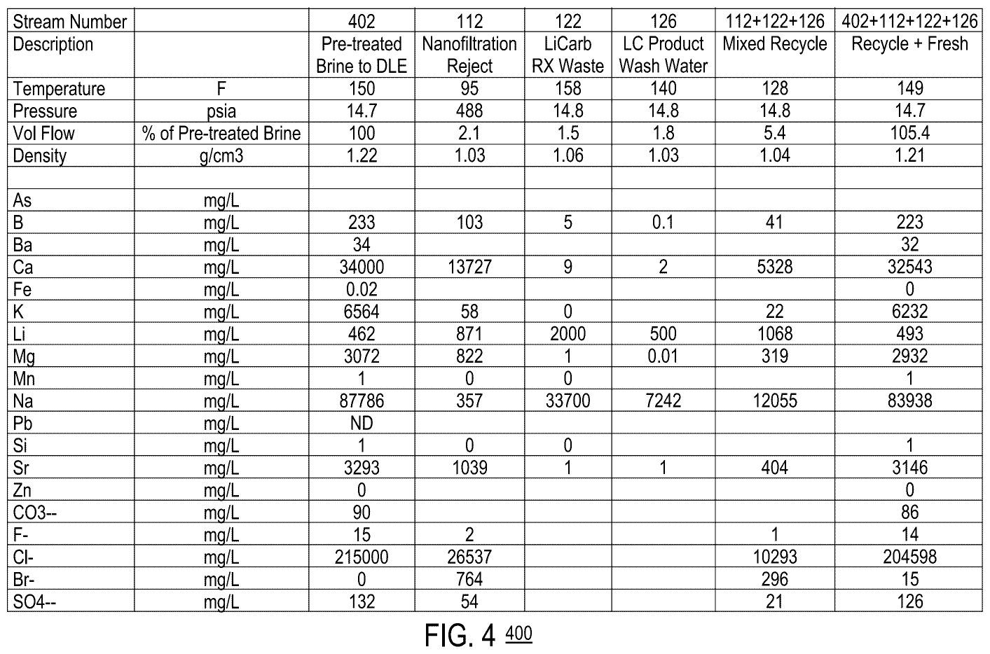

The apparatus 100 also includes a lithium carbonate reaction unit 120 is fluidically coupled to the concentration unit 118. In various embodiments, the lithium carbonate reaction unit 120 receives purified and concentrated lithium solution from the concentration unit 118. The lithium carbonate reaction unit 120 may initiate a conversion process to produce a saleable battery grade lithium product. For example, the conversion process may include the use of a crystallizer that can generate lithium carbonate (Li₂CO₃). For example, the lithium carbonate reaction unit 120 can convert lithium salts such as lithium chloride into lithium carbonate crystals. The lithium carbonate reaction unit 120 also generates a lithium carbonate reaction waste stream 122 that includes byproducts of the conversion process as well as some lithium. In various embodiments, the lithium carbonate reaction waste stream 122 includes some amounts of lithium, as well as potassium, and large amounts of sodium, with trace amounts of calcium, magnesium, boron, and other divalents, as shown in FIG. 4. In some embodiments, the lithium carbonate reaction waste stream 122 is treated to convert any lithium solids into a solution. For example, the lithium may be substantially converted into lithium chloride or lithium bromide. As one example, the lithium may be converted via an acidification by adding an acid, such as hydrochloric acid (HCl), or sulfuric acid (H₂SO₄), or any other suitable acid.

The apparatus 100 further also includes a product wash unit 124 fluidically coupled to the lithium carbonate reaction unit 120. In the embodiment of FIG. 1, the product wash unit 124 is shown receiving a stream of lithium carbonate and outputting produced solids and product wash waste stream 126. In various embodiments, the product wash unit 124 also receives a wash water stream (not shown) for washing. In some embodiments, the wash water is deionized (DI) water. In various embodiments, the produced solids are lithium carbonate solids that are not completely dry. As one example, a stream of wash water may be introduced to generate an output of wash waste water of which a selected subset of wash water streams are recycled. In various embodiments, the product wash unit 124 may perform any number of washes on lithium carbonate received from the lithium carbonate reaction unit 120 using the wash water. As one example, the product wash unit 124 may take the form of a horizontal belt filter with a conveyor belt that moves lithium carbonate crystals in a filter through a series of hoses that wash the lithium carbonate with wash water. The wash water extracts sodium and lithium chloride that dissolves in the wash water and passes through the filter, leavening purified lithium carbonate crystals behind. In this manner, any number of water washes may be performed in a sequential manner resulting in a number of sequential wash water streams containing less and less sodium, while removing approximately the same amount of lithium chloride in each wash. In various embodiments, any number of washes may be used. In various embodiments, a selected number of the resulting wash water streams are used for recycling. As one embodiment, a first wash water stream may be discarded and subsequent wash water streams recycled for use as selected wash water streams. For example, the first wash water stream may be particularly high in certain extracted salts such as sodium and thus discarded. The compositions of an example product wash stream with associated nanofiltration reject stream, and lithium carbonate waste stream of an example input brine stream that was processed using a simulation is shown and described with respect to FIG. 4 below.

The apparatus 100 also further includes a product drying and packaging unit 128 that dries and packages the lithium carbonate received from the product wash unit 124 to produce a product 130. For example, the product 130 may be a lithium carbonate with a purity of at least 99% or 99.5%.

As shown in FIG. 1, the nanofiltration waste stream 112, the lithium carbonate reaction waste stream 122, and the product wash waste stream 126, form a recycle stream 132 that is recycled back into the apparatus 100 at just before the lithium extraction unit 106, as indicated by an arrow. For example, in some embodiments, the apparatus 100 includes a mixer (not shown) to mix the recycle stream 132 with pre-treated brine stream from the brine pre-treatment unit 104 and send the mixed stream into the lithium extraction unit 106.

It is to be understood that the block diagram of FIG. 1 is not intended to indicate that the apparatus 100 is to include all of the components shown in FIG. 1. Rather, the apparatus 100 can include fewer or additional components not illustrated in FIG. 1 (e.g., additional streams, products, or additional processing units, such as mixers, pumps, etc.). In addition, in various embodiments, the specific order in which the streams are processed via the various units may be different depending on the specific composition of the input fresh brine stream. For example, in various embodiments, the nanofiltration unit 110, the ion exchange unit 114, the reverse osmosis unit 116, and/or the concentration unit 118, may be connected in any suitable order. In addition, in some embodiments, the recycle stream 132 may alternatively be sent as an input stream into the nanofiltration unit 110. In still other embodiments the recycle stream 132 may be provided as an input to the reverse osmosis unit 116, the ion exchange unit 114, the lithium carbonate reaction unit 120, or any other suitable processing unit.

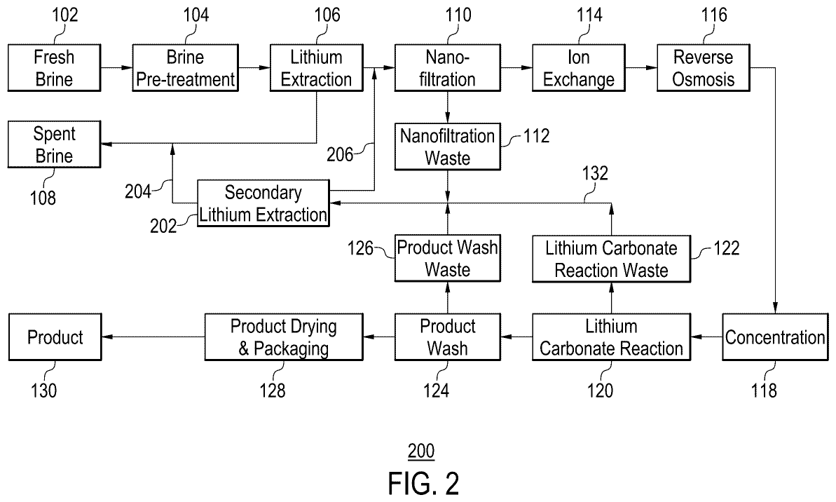

FIG. 2 is a block diagram of another apparatus 200 for the removal of ions from a brine stream using a recycle stream and secondary lithium extraction. In various embodiments, the apparatus is used to implement the method 300B of FIG. 3B. The apparatus 200 of FIG. 2 includes similarly referenced elements of FIG. 1. In addition, the apparatus 200 includes a secondary lithium extraction unit 202 fluidically coupled to the nanofiltration unit 110, the lithium carbonate reaction unit 120, and the product wash unit 124 to receive the nanofiltration waste stream 112, lithium carbonate reaction waste stream 122, and product wash waste stream 126.

In various embodiments, the secondary lithium extraction unit 202 extracts lithium using a fresh water stream (not shown), similar to the lithium extraction unit 106. The secondary lithium extraction unit 202 thus generates a secondary extraction waste stream 204 that is sent to be disposed of along with the spent brine 108. The secondary lithium extraction unit 202 also further generates a processed recycle stream 206 that is sent to be mixed with the output of the lithium extraction unit 106. The resulting mixture is then processed by the nanofiltration unit 110 and other units, as described in FIG. 1. In various embodiments, the apparatus 200 with the secondary lithium extraction unit 202 is optimized based on relative flow rates, capital investment, and operating expenses. For example, such optimizations may include examining whether it is cheaper to increase the capacity of the primary lithium extraction unit (including both capital and operating expenses) versus building a secondary lithium extraction unit. Thus, such optimization may determine whether the use of a larger facility versus using extra facilities is more optimal.

It is to be understood that the block diagram of FIG. 2 is not intended to indicate that the apparatus 200 is to include all of the components shown in FIG. 2. Rather, the apparatus 200 can include fewer or additional components not illustrated in FIG. 2 (e.g., additional streams, products, or additional units, such as mixers, pumps, etc.). In addition, in various embodiments, the specific order in which the streams are processed via the various units may be different depending on the specific composition of the input fresh brine stream.

FIG. 3A is a process flow diagram of a method 300A for recycling waste streams. In various embodiments, the method 300A may be implemented using the apparatus 100 of FIG. 1.

At block 302, a nanofilter waste stream, a product wash waste stream, and lithium carbonate reaction waste stream is received. For example, the nanofilter reject stream and a wash waste water stream may both be byproducts of the additional processing of an output stream from a DLE by various components of a lithium conversion process. In various embodiments, the nanofilter waste stream is a stream output from a nanofilter. In various examples, the nanofilter reject stream may include a percentage of lithium from the original feed in the range of one to ten percent. In some embodiments, the received product wash waste may be a mix of a selected number of product wash waste streams. For example, a number of product wash waste streams may be generated by successively washing lithium carbonate crystals with fresh water. In some embodiments, the first wash may be discarded, with subsequent waste washes selected to be mixed to generate a selected wash waste stream.

At block 304, at least a fraction of each of at least two of the nanofilter waste stream, the product wash waste stream, and the lithium carbonate reaction waste stream, is blended to generate a recycle stream. In various embodiments, any combination of a nanofilter reject stream, a wash waste water stream, and a lithium carbonate waste stream is blended to generate the recycle stream. For example, in some embodiments, the lithium carbonate waste stream is blended with either the nanofilter reject stream, or a wash waste water stream, to generate the recycle stream. In various embodiments, the lithium carbonate waste stream, the wash waste water stream, or both, may be treated with acid to dissolve any lithium carbonate solids. For example, the acid treatment may be used to convert any lithium carbonate solids in the blend back into a solute form, such as lithium chloride. In some embodiments, the nanofilter reject stream is combined with the wash waste water stream to generate the recycle stream. Alternatively, in various embodiments, any one of the nanofilter reject stream, a wash waste water stream, or the lithium carbonate waste stream may be used as a recycle stream. In some embodiments, the nanofiltration waste stream may be over acidified before being mixed into the blend. For example, an excess of acid may be added to the nanofiltration waste stream such that the excess unreacted acid dissolves any lithium carbonate solids that may be present in the lithium carbonate waste stream or the wash waste water stream when mixed with the nanofiltration waste stream.

At block 306, the recycle stream is sent back into the lithium extraction unit for recycling. For example, in some embodiments, the recycle stream is mixed with pre-treated brine and processed via the lithium extraction unit. The lithium rich brine may then be sent to a nanofiltration unit among other units for further processing into a lithium product. In particular, because the volume of the recycle stream is much lower compared to the pre-treated brine stream, the lithium extraction unit may process the mix without any other adjustments. For example, the volume of the recycle stream may be within the typical range of normal fluctuations in the volume of the pre-treated brine stream. As one example, the combined volume of the recycle stream may be about 5% of the volume of the input pre-treated brine stream that is treated by the lithium extraction unit. Thus, the method 300A provides a cost-effective method of improving lithium extraction efficiency.

The process flow diagram of FIG. 3A is not intended to indicate that the processes of the method 300A are to be executed in any particular order, or that all of the processes of the method 300A are to be included in every case. Additionally, the method 300A can include any suitable additional processing of the brine. For example, in some embodiments, the method 300A may include the use of a separate nanofiltration train that is dedicated to the recycle stream. For example, in some embodiments, the recycle stream may be processed using a secondary DLE unit before being sent to the DLE unit, as described in FIG. 3B.

FIG. 3B is a process flow diagram of a method for recycling waste streams using a secondary lithium extraction unit. In various embodiments, the method 300B may be implemented using the apparatus 200 of FIG. 2

The method 300B includes similarly referenced blocks of method 300A of FIG. 3A. For example, at block 302, a nanofilter waste stream, a product wash waste stream, and lithium carbonate reaction waste stream is received. Similarly, at block 304, at least a fraction of at least two of the nanofilter waste stream, the product wash waste stream, and the lithium carbonate reaction waste stream, is blended to generate a recycle stream.

In addition, at block 308, the generated recycle stream is processed in a secondary lithium extraction unit for extraction of lithium. For example, the secondary lithium extraction unit can extract lithium from the generated recycle stream using a fresh water stream to produce a processed recycle stream.

At block 310, the processed recycle stream is sent into a nanofiltration unit for recycling. For example, the nanofiltration unit may be the same nanofiltration unit that receives a stream from a primary lithium extraction unit.

At block 312, a secondary extraction waste stream is sent into a spent brine stream for disposal. For example, the spent brine stream may be processed and deposited into a reservoir via a well, or disposed of otherwise as appropriate.

The process flow diagram of FIG. 3B is not intended to indicate that the processes of the method 300B are to be executed in any particular order, or that all of the processes of the method 300B are to be included in every case. Additionally, the method 300B can include any suitable additional processing of the brine.

FIG. 4 is a chart 400 depicting components of various example streams. The chart 400 includes similarly referenced byproduct streams of FIGS. 1 and 2. The chart 400 further includes a pre-treated brine to DLE stream 402, which may have been produced by the brine pre-treatment unit 104 of FIGS. 1 and 2 and further treated by the lithium extraction unit before being sent to other units for additional processing. As seen in FIG. 4, the nanofiltration waste stream 112 is particularly relatively high in calcium with a value of 13,727 milligrams per liter (mg/L.

Thus, the blend feed can be effectively processed via a lithium extraction unit to generate additional purified lithium from additional produced solids. In some embodiments, since the concentration of impurities in the recycle stream may be higher than the pre-treated brine to DLE feed 402, the recycle stream may be input into a secondary lithium extraction unit that is specialized for the mixed recycle stream, as discussed in FIG. 2. The extracted stream can then be processed along with the output of the primary lithium extraction unit at a nanofiltration unit. In this manner, the recycle stream can be used to maximize lithium recovery from the brine stream.

Alternatively, or in addition, the recycle stream is used to enable a nanofiltration unit to operate sub-optimally and still recover similar amounts of lithium. For example, in one embodiment, the nanofiltration system is configured to pass more lithium in order to reject more divalents, with this additional lost lithium being recovered in a second pass via the recycle stream. Similarly, in another embodiment, the recycle stream is alternatively or additionally used to enable the lithium carbonate reaction unit or the product wash unit to operate sub-optimally with respect to lithium extraction. For example, allowing greater amounts of lithium to be removed into the wash streams may also enable larger amounts of sodium to be removed, with the this additional lost lithium again being recovered in the second pass via the recycle stream. In some examples, even if 80% of the lithium in the recycle stream is recovered in the second pass, this recovered amount may be up to 12% of the lithium in the original DLE feed that may have otherwise been discarded.

### Embodiments of Present Techniques

In one or more embodiments, the present techniques may be susceptible to various modifications and alternative forms, such as the following embodiments as noted in paragraphs 1 to 30:
1. An apparatus for brine filtration includes a recycling unit to receive a nanofiltration waste stream, a product wash waste stream, a lithium carbonate reaction waste stream, or any combination thereof. The recycling unit is to also blend at least a fraction of each of at least two of the nanofiltration waste stream, the product wash waste stream, and the lithium carbonate reaction waste stream to generate a recycle stream.
2. The apparatus of paragraph 1, where the lithium extraction unit includes a primary lithium extraction unit that receives pre-treated brine.
3. The apparatus of any of paragraphs 1 and 2, where the recycling unit includes a secondary lithium extraction unit to process the generated recycle stream for extraction of lithium.
4. The apparatus of paragraph 3, where the processed recycle stream is sent to a nanofiltration unit for recycling.
5. The apparatus of paragraph 3, where a secondary extraction waste stream is sent to a spent brine stream for disposal. v6. The apparatus of any of paragraphs 1-5, where the lithium extraction unit includes a direct lithium extraction unit that also receives a pre-treated brine stream.
7. The apparatus of any of paragraphs 1-6, where the product wash waste stream includes a plurality of selected wash water streams generated by a product wash unit.
8. The apparatus of any of paragraphs 1-7, including a mixer to mix the generated recycle stream with a pre-treated brine stream and send the mixed stream into the lithium extraction unit.
9. The apparatus of any of paragraphs 1-8, including a nanofiltration unit to generate the nanofiltration waste stream as a byproduct of filtration.
10. The apparatus of any of paragraphs 1-9, including a product wash unit to generate the product wash waste stream as a byproduct of washing lithium carbonate.
11. The apparatus of any of paragraphs 1-10, including a lithium carbonate reaction unit to generate the lithium carbonate reaction waste stream as a byproduct of producing lithium carbonate.
12. The apparatus of any of paragraphs 1-11, including a washing unit to generate the product wash waste stream, where the washing unit is individually sub-optimally configured with respect to lithium extraction.
13. The apparatus of any of paragraphs 1-11, where the recycling unit is to send the generated recycle stream into a lithium extraction unit.
14. The apparatus of any of paragraphs 1-11, where the recycling unit is to send the recycle stream into a nanofiltration unit.
15. The apparatus of any of paragraphs 1-11, where the recycling unit is to convert lithium carbonate in the recycle stream into lithium chloride or lithium bromide.
16. The apparatus of any of paragraphs 1-11, where the blend comprises the lithium carbonate reaction waste stream and the product wash waste stream.
17. The apparatus of paragraph 16, where the blend is treated with an acid before being input into a lithium extraction unit.
18. The apparatus of any of paragraphs 1-11, where the blend comprises the lithium carbonate reaction waste stream and the nanofiltration waste stream.
19. The apparatus of any of paragraphs 1-11, where the blend comprises the product wash waste stream and the nanofiltration waste stream.
20. The apparatus of paragraphs 18 or 19, where the nanofiltration waste stream is over acidified before being mixed into the blend.
21. The apparatus of any of paragraphs 1-11, where the product wash waste stream, or the lithium carbonate reaction waste stream, or both, are treated with acid before being mixed into the blend.
22. A method of producing a recycle stream includes receiving a nanofiltration waste stream, a product wash waste stream, a lithium carbonate reaction waste stream, or any combination thereof. The method includes blending at least a fraction of each of at least two of: the nanofiltration waste stream, the product wash waste stream, and the lithium carbonate reaction waste stream to generate the recycle stream.
23. The method of paragraph 22, including processing the recycle stream via a secondary lithium extraction unit to extract lithium from the recycle stream and generate a processed recycle stream.
24. The method of paragraph 23, including sending the processed recycle stream into a nanofiltration unit for recycling.
25. The method of paragraph 23, including mixing the processed recycle stream with output of a primary lithium extraction unit, and sending the mixed stream into a nanofiltration unit for recycling.
26. The method of paragraph 24 or 25, where the nanofiltration unit also generates the nanofiltration waste stream.
27. The method of any of paragraphs 23-26, comprising acidifying the recycle stream before sending the stream into the secondary lithium extraction unit.
28. The method of paragraph 22, comprising sending the recycle stream into a primary lithium extraction unit that also receives pre-treated brine from a brine pre-treatment unit.
29. The method of paragraph 28, comprising acidifying the recycle stream before sending the recycle stream into the primary lithium extraction unit.
30. The method of paragraph 29, wherein acidifying the recycle stream comprises adding acid to the nanofiltration waste stream, the product wash waste stream, the lithium carbonate reaction waste stream, or any combination thereof, prior to the blending.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present disclosure may be modified and practiced in different but equivalent manners apparent to those skilled in the art having the benefit of the teachings herein. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present disclosure includes all alternatives, modifications, and equivalents falling within the true spirit and scope of the appended claims.

What is claimed is:

1. An apparatus for brine filtration, comprising:
a recycling unit to:
receive a nanofiltration waste stream, a product wash waste stream, a lithium carbonate reaction waste stream, or any combination thereof; and
blend at least a fraction of each of two of the nanofiltration waste stream, the product wash waste stream, and the lithium carbonate reaction waste stream to generate a recycle stream.

2. The apparatus of claim 1, wherein the lithium extraction unit comprises a primary lithium extraction unit that receives pre-treated brine.

3. The apparatus of claim 1, wherein the recycling unit comprises a secondary lithium extraction unit to process the generated recycle stream for extraction of lithium.

4. The apparatus of claim 3, wherein the processed recycle stream is sent to a nanofiltration unit for recycling.

5. The apparatus of claim 3, wherein a secondary extraction waste stream is sent to a spent brine stream for disposal.

6. The apparatus of claim 1, wherein the lithium extraction unit comprises a direct lithium extraction unit that also receives a pre-treated brine stream.

7. The apparatus of claim 1, wherein the product wash waste stream comprises a plurality of selected wash water streams generated by a product wash unit.

8. The apparatus of claim 1, comprising a mixer to mix the generated recycle stream with a pre-treated brine stream and send the mixed stream into the lithium extraction unit.

9. The apparatus of claim 1, comprising a nanofiltration unit to generate the nanofiltration waste stream as a byproduct of filtration.

10. The apparatus of claim 1, comprising a product wash unit to generate the product wash waste stream as a byproduct of washing lithium carbonate.

11. The apparatus of claim 1, comprising a lithium carbonate reaction unit to generate the lithium carbonate reaction waste stream as a byproduct of producing lithium carbonate.

12. The apparatus of claim 1, comprising a washing unit to generate the product wash waste stream, wherein the washing unit is individually sub-optimally configured with respect to lithium extraction.

13. The apparatus of claim 1, wherein the recycling unit is to send the generated recycle stream into a lithium extraction unit.

14. The apparatus of claim 1, wherein the recycling unit is to send the recycle stream into a nanofiltration unit.

15. The apparatus of claim 1, wherein the recycling unit is to convert lithium carbonate in the recycle stream into lithium chloride or lithium bromide.

16. The apparatus of claim 1, wherein the blend comprises the lithium carbonate reaction waste stream and the product wash waste stream.

17. The apparatus of claim 16, wherein the blend is treated with an acid before being input into a lithium extraction unit.

18. The apparatus of claim 1, wherein the blend comprises the lithium carbonate reaction waste stream and the nanofiltration waste stream.

19. The apparatus of claim 1, wherein the blend comprises the product wash waste stream and the nanofiltration waste stream.

20. The apparatus of claim 18, wherein the nanofiltration waste stream is over acidified before being mixed into the blend.

21. The apparatus of claim 1, wherein the product wash waste stream, or the lithium carbonate reaction waste stream, or both, are treated with acid before being mixed into the blend.

22. A method of producing a recycle stream, comprising:
receiving a nanofiltration waste stream, a product wash waste stream, a lithium carbonate reaction waste stream, or any combination thereof; and
blending at least a fraction of each of two of the nanofiltration waste stream, the product wash waste stream, and the lithium carbonate reaction waste stream to generate the recycle stream.

23. The method of claim 22, comprising processing the recycle stream via a secondary lithium extraction unit to extract lithium from the recycle stream and generate a processed recycle stream.

24. The method of claim 23, comprising sending the processed recycle stream into a nanofiltration unit for recycling.

25. The method of claim 23, comprising mixing the processed recycle stream with output of a primary lithium extraction unit, and sending the mixed stream into a nanofiltration unit for recycling.

26. The method of claim 24, wherein the nanofiltration unit also generates the nanofiltration waste stream.

27. The method of claim 23, comprising acidifying the recycle stream before sending the stream into the secondary lithium extraction unit.

28. The method of claim 22, comprising sending the recycle stream into a primary lithium extraction unit that also receives pre-treated brine from a brine pre-treatment unit.

29. The method of claim 28, comprising acidifying the recycle stream before sending the recycle stream into the primary lithium extraction unit.

30. The method of claim 29, wherein acidifying the recycle stream comprises adding acid to the nanofiltration waste stream, the product wash waste stream, the lithium carbonate reaction waste stream, or any combination thereof, prior to the blending.
